(19) United States
(12) Patent Application Publication
(10) Pub. No.: US 2020/0104032 A1
(43) Pub. Date: Apr. 2, 2020

(54) POPUP NOTIFICATION SIZE AND LOCATION BASED ON PUBLIC-SAFETY EVENT

(71) Applicant: MOTOROLA SOLUTIONS, INC, CHICAGO, IL (US)

(72) Inventor: GUO DONG GAN, KUALA LUMPUR (MY)

(21) Appl. No.: 16/143,536

(22) Filed: Sep. 27, 2018

(51) Int. Cl. G06F 3/0484; H04W 4/16; H04L 12/58; G06F 9/54

(52) U.S. Cl. CPC G06F 3/04842; G06F 9/542; H04L 51/24; H04W 4/16

(57) ABSTRACT

A method and apparatus for managing the size and location of a popup notification is provided herein. During operation a device will have knowledge of a status of sensors connected to form a personal-area network (PAN) and/or have knowledge of a current incident type assigned to a user. The device will then adjust a size and/or location of a popup notification based on the status of associated PAN devices and/or the incident type. Thus, a size and/or location of any popup notification will be based on a fact that a public-safety event has occurred, with the public-safety event comprising a current incident assigned to a user, or a status of at least one device/sensor connected to form a PAN.

### BACKGROUND OF THE INVENTION

Next-generation public-safety radios used by public-safety officers will offer enriched software applications to be displayed onto a touch display. As one of an ordinary skill in the art will recognize, management for display real estate is very critical for many use cases. It is critical that notification popups and other UI operations do not block critical public safety information. For example, consider a police officer in the process of typing a message on a messaging application to broadcast an emergency to his peers, when suddenly a less critical application's popup appears over the messaging application. The Officer will then need to cancel the popup and return to the typing the emergency message. This wastes valuable time.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operational environment for the present invention.

FIG. 2 depicts an example communication system.

FIG. 3 is a more-detailed view of a personal-area network of FIG. 2.

FIG. 4 is a block diagram of a hub.

FIG. 5 through FIG. 8 illustrate popup message display.

FIG. 9 is a flow chart showing operation of the hub of FIG. 4.

FIG. 10 is a flow chart showing operation of the hub of FIG. 4.

FIG. 11 is a flow chart showing operation of the hub of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for managing the size and location of a popup notification is provided herein. During operation a device will have knowledge of a status of sensors connected to form a personal-area network (PAN) and/or have knowledge of a incident types assigned to a user. The device will then adjust a size and/or location of a popup notification based on the status of associated PAN devices and/or the incident type. Thus, a size and/or location of any popup notification will be based on a fact that a public-safety event has occurred, with the public-safety event comprising a current incident assigned to a user, or a status of at least one device/sensor connected to form a PAN.

Expanding on the above, a public-safety event is used to determine appropriate way for an application in the background to push a popup notification to the foreground, in a way that is least disruptive to the user's current task. Instead of a “full push to foreground” which takes over the entire screen (or a large portion of it) of the device. In many situations, a “partial push to foreground” may be more appropriate. The percentage of screen size of a “partial push to foreground” is based on the user's current action and current context on the current application. Current context comprises the percentage of completion of current user action, timed actions, increasing priority of popup, expedited incoming calls, . . . , etc. So, for example, the percentage of the screen size a popup takes may increase as a user inputs text (e.g., 5% for every letter input).

In an embodiment of the present invention, the popup notifications originate from application software. Application software comprises any program, or group of programs, that is designed for the end user. Applications software (also called end-user programs) include such things as database programs, Push-to-Talk applications, messaging applications, word processors, Web browsers, calendars, spreadsheets, . . . , etc.

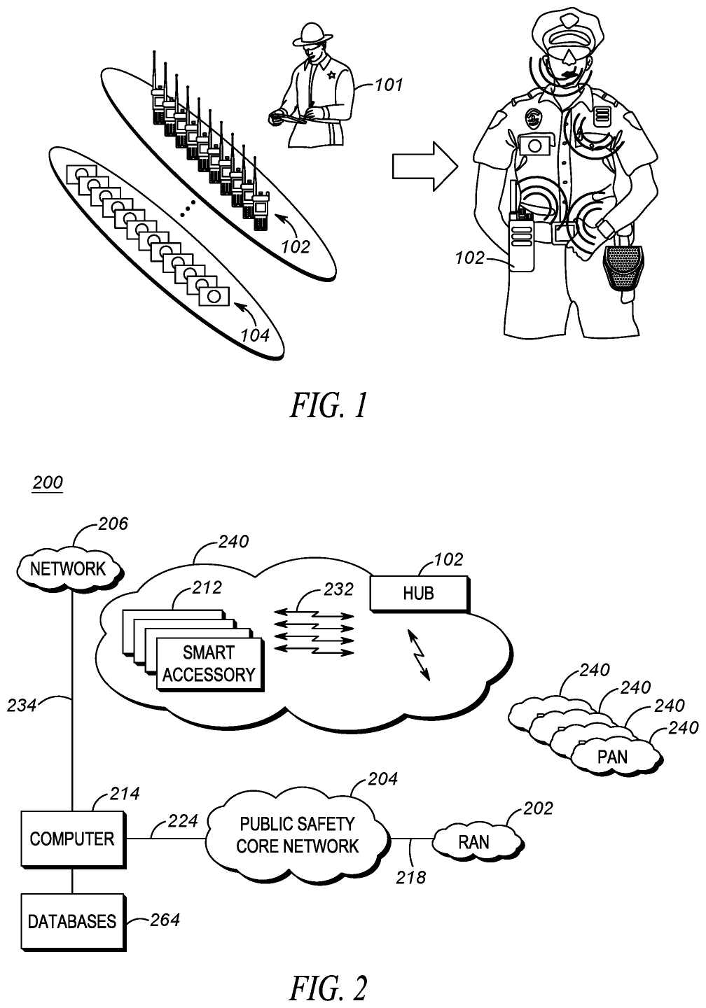

Turning now to the drawings, wherein like numerals designate like components, FIG. 1 illustrates an operational environment for the present invention. As shown, a public safety officer 101 will be equipped with devices that determine various physical and environmental conditions surrounding the public-safety officer. These conditions are generally reported back to a dispatch center so an appropriate action may be taken. For example, future police officers may have a sensor that determines when a gun is drawn. Upon detecting that an officer has drawn their gun, a notification may be sent back to the dispatch operator so that, for example, other officers in the area may be notified of the situation.

It is envisioned that the public-safety officer will have an array of shelved devices available to the officer at the beginning of a shift. The officer may select some of the devices off the shelf, and form a personal area network (PAN) with the devices that will accompany the officer on his shift. For example, the officer may acquire a gun-draw sensor, a body-worn camera, a wireless microphone, a smart watch, a police radio, smart handcuffs, a man-down sensor, a bio-sensor, . . . , etc. All devices acquired by the officer will be configured to form a PAN by associating (pairing) with each other and communicating wirelessly among the devices. In a preferred embodiment, the PAN comprises more than two devices, so that many devices are connected via the PAN simultaneously.

A method called bonding is typically used for recognizing specific devices and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device.

As shown in FIG. 1, public-safety officer 101 has an array of devices to use during the officer's shift. For example, the officer may acquire one radio 102 and one camera 104 for use during their shift. Other devices may be acquired as well. As shown in FIG. 1, officer 101 will preferably wear the devices during a shift by attaching the devices to clothing. These devices will form a PAN throughout the officer's shift.

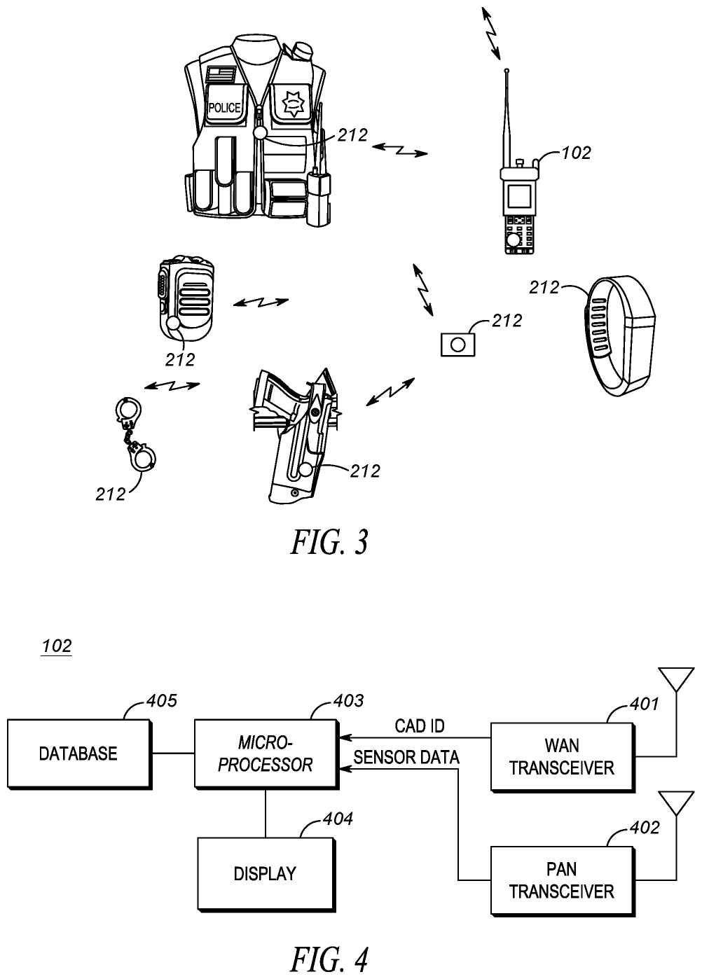

FIG. 2 depicts an example communication system 200 that incorporates PANs created as described above. System 200 includes one or more radio access networks (RANs) 202, a public-safety core network 204, high-speed data network 206, hub (PAN master device) 102, local devices (slave devices that serve as smart accessories/sensors) 212, computer 214, and communication links 218, 224, 232, and 234. In a preferred embodiment of the present invention, hub 102 and devices 212 form PAN 240, with communication links 232 between devices 212 and hub 102 taking place utilizing a short-range wireless communication system protocol such as a Bluetooth communication system protocol. Each officer will have an associated PAN 240. Thus, FIG. 2 illustrates multiple PANs 240 associated with multiple officers.

RAN 202 includes typical RAN elements such as base stations, base station controllers (BSCs), routers, switches, and the like, arranged, connected, and programmed to provide wireless service to user equipment (e.g., hub 102, and the like) in a manner known to those of skill in the relevant art. RAN 202 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards.

High-speed data network 206 is provided. Network 206 may comprise a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, network 206 may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

Sensor 212 data (which may include video) shared among officers (and reported to dispatch center 214) is typically (but not necessarily) accomplished by utilizing network 206, capable of achieving large data rates, while voice communications take place through network 204. Thus, voice communications among public-safety officers typically take place through one network, while data shared among public-safety officers typically take place through another network.

Public-safety core network 204 may include one or more packet-switched networks and/or one or more circuit-switched networks, and in general provides one or more public-safety agencies with any necessary computing and communication needs, transmitting any necessary public-safety-related data and communications.

For narrowband LMR wireless systems, core network 204 operates in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some embodiments, group IDs may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between wireless and/or wireline participants in accordance with either a narrowband or a broadband protocol or standard. Group members for group calls may be statically or dynamically defined. That is, in a first example, a user or administrator may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) perhaps based on user input, and the switching and/or radio network may track group membership and route new group calls according to the current group membership.

Hub 102 serves as a PAN master device, and may be any suitable computing and communication device configured to engage in wireless communication with RAN 202 and/or network 206 over the air interface as is known to those in the relevant art. Moreover, one or more hubs 102 are further configured to engage in wired and/or wireless communication with one or more local device 212 via the communication link 232. Hub 102 will be configured to determine when to forward information received from PAN devices 212 to, for example, dispatch center 214. The information can be forwarded to the dispatch center via RANs 202 and/or network 206 based on a combination of device 212 inputs. In one embodiment, all information received from sensors 212 will be forwarded to center 214 via RAN 202 or network 206. In another embodiment, hub 102 will filter the information sent, and only send high-priority information back to dispatch center 214.

It should also be noted that any one or more of the communication links 218, 224, 232, 234 could include one or more wireless-communication links and/or one or more wired-communication links.

In a preferred embodiment, devices 212 and hub 102 comprise any device capable of forming a PAN, although the present invention may be implemented for devices not forming a PAN. Devices 212 may comprise, for example, a gun-draw sensor, a body temperature sensor, an accelerometer, a heart-rate sensor, a breathing-rate sensor, a camera, a man-down sensor, a GPS receiver capable of determining a location, speed, and direction of the user device, smart handcuffs, a clock, calendar, sound detector, environmental sensors (e.g. a thermometer capable of determining an ambient temperature, humidity, presence of dispersed chemicals, radiation detector, electric field detector, magnetic field detector, etc.), an accelerometer, a biometric sensor (e.g., wristband), a barometer, speech recognition circuitry, a gunshot detector, an ambient sound detector . . . , etc. Some examples follow:

A sensor-enabled holster 212 may be provided that maintains and/or provides state information regarding a weapon or other item normally disposed within the user's sensor-enabled holster 212. The sensor-enabled holster 212 may detect a change in state (presence to absence) and/or an action (removal) relative to the weapon normally disposed within the sensor-enabled holster 212. The detected change in state and/or action may be reported to a portable radio acting as hub 102 via its short-range transceiver. In some embodiments, the sensor-enabled holster may also detect whether the first responder's hand is resting on the weapon even if it has not yet been removed from the holster and provide such information to portable radio 102. Other possibilities exist as well. Such sensor-enabled holsters typically comprise a switch that is “pressed” when a gun is inserted into a holster. Removal of the gun causes the switch to activate.

A biometric sensor 212 (e.g., a biometric wristband) may be provided for tracking an activity of the user or a health status of the user 101, and may include one or more movement sensors (such as an accelerometer, magnetometer, and/or gyroscope) that may periodically or intermittently provide to the portable radio (acting as hub 102) indications of orientation, direction, steps, acceleration, and/or speed, and indications of health such as one or more of a captured heart rate, a captured breathing rate, and a captured body temperature of the user 101, perhaps accompanying other information.

An accelerometer 212 may be provided to measures acceleration and provide this information to hub 102. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

A heart rate sensor 212 may be provided and use electrical contacts with the skin to monitor an electrocardiography (EKG) signal of its wearer, or may use infrared light and imaging device to optically detect a pulse rate of its wearer, among other possibilities, and report this information to hub 102.

A breathing rate sensor 212 may be provided to monitor breathing rate and provide this information to hub 102. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperature sensor 212 may be provided, and report temperature to hub 102. Such a sensor includes an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities. Temperature sensor 212 may be used on equipment to determine if the equipment is being worn or not. For example, temperature sensor 212 may exist interior to a bullet-proof vest. I the temperature sensor 212 senses a temperature above a predetermined threshold (e.g., 80 degrees), it may be assumed that the vest is being worn by an officer.

Computer 214 comprises, or is part of, a computer-aided-dispatch center (sometimes referred to as an emergency-call center), that may be manned by an operator providing necessary dispatch operations. For example, computer 214 typically comprises a graphical user interface that provides the dispatch operator necessary information about public-safety officers. As discussed above, much of this information originates from devices/sensors 212 providing information to hub 102, which forwards the information to RAN 202/network 206 and ultimately to computer 214.

A computer-aided dispatch (CAD) incident identifier can be utilized by computer 214 to determine a current context for each user. An incident identification (sometimes referred to as an incident scene identifier, or a CAD incident identifier (CAD ID)) is generated for incidents where an officer is dispatched/assigned, or where an officer encounters a public-safety event. This ID (which is assigned to an officer) could be something as simple as a number associated with a particular incident type, or something as complicated as an identification that is a function of populated fields (e.g., time, location, incident type, . . . , etc.), one of which may comprise an incident type. The CAD ID may be provided to hub 102 so that hub 102 may manage popups on its screen as described above.

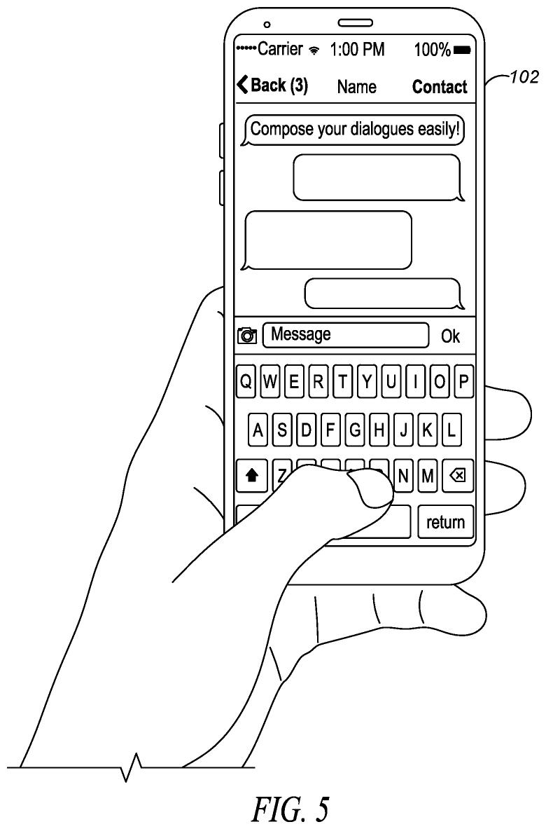

FIG. 3 depicts another view of a personal-area network 240 of FIG. 2. Personal-area network comprises a very local-area network that has a range of, for example 10 feet. As shown in FIG. 3, various devices 212 are that attach to clothing utilized by a public-safety officer. In this particular example, a bio-sensor is located within a police vest, a voice detector is located within a police microphone, smart handcuffs 212 are usually located within a handcuff pouch (not shown), a gun-draw sensor is located within a holster, a smart watch 212 is provided to monitor various biological parameters (e.g., heartrate, blood pressure, . . . , etc.) and a camera 212 is provided.

Devices 212 and hub 102 form a PAN 240. PAN 240 preferably comprises a Bluetooth PAN. Devices 212 and hub 102 are considered Bluetooth devices in that they operate using a Bluetooth, a short range wireless communications technology at the 2.4 GHz band, commercially available from the “Bluetooth special interest group”. Devices 212 and hub 102 are connected via Bluetooth technology in an ad hoc fashion forming a PAN. Hub 102 serves as a master device while devices 212 serve as slave devices.

Hub 102 provides information to the officer, and/or forwards local status alert messages describing each sensor state/trigger event over a wide-area network (e.g., RAN/Core Network) to computer 214. In alternate embodiments of the present invention, hub 102 may forward the local status alerts/updates for each sensor to mobile and non-mobile peers (shift supervisor, peers in the field, etc), or to the public via social media. RAN core network preferably comprises a network that utilizes a public-safety over-the-air protocol. Thus, hub 102 receives sensor data via a first network (e.g., Bluetooth PAN network), and forwards the information to computer 214 via a second network (e.g., a public safety wide area network (WAN) or a high-speed data network (WAN)).

As described above, for hub 102, a public-safety event is used to determine an appropriate way for an application in the background to push a popup notification to the foreground, in a way that is least disruptive to the user's current task. Instead of a “full push to foreground” which takes over the entire screen of the device. In many situations, a “partial push to foreground” may be more appropriate. The percentage of screen size of a “partial push to foreground” is based on the user's current action and current context on the current application. Current context comprises the percentage of completion of current user action, timed actions, increasing priority of popup, expedited incoming calls, . . . , etc.

In order to address this issue, hub 102 will adjust the size and location of any popup notifications from applications based on public-safety events. These events may include the status of sensors 212, processed sensor data, and/or an incident type (CAD ID) currently assigned to an officer.

For example, if dispatch center 214, or hub 102 detects that Officer Smith has drawn his gun, hub 102 will reduce a size of any popup notifications from applications that are determined as non-critical to the situation of having a gun drawn. As is evident, popup notifications from applications have their size determined dynamically (based on a public-safety event) and not by a fixed priority. Thus, those popups belonging to applications considered critical for a first event, may not be considered critical for a second event. In other words, those popups that may take up a large portion of a screen during one event (e.g. bank robbery), may only take up a small portion of the screen during another event (e.g., foot pursuit).

An event can be determined by an incident type as determined by a CAD_ID. In this situation, popup notifications from applications have their size and/or location based on a current incident assigned to a public-safety officer.

An event can comprise a status of PAN devices. In this situation, popup notifications from applications have their size and/or location based on a current status of one or more PAN devices/sensors.

So, for example, an officer assigned a first incident, having a first CAD ID, will have certain popup notifications from applications restricted (i.e., occupying a smaller area on the screen, or even occupying no area of the screen), and an officer assigned a second incident, having a second CAD ID, will not have the same popup notifications from applications restricted (i.e., the popup notifications from applications will take up a larger portion of the screen than when restricted). The popup size and/or location assigned to a particular notification can be set either manually by the dispatch operator, or may be pre-programmed.

Expanding on the above, assume a dispatch operator receives an emergency call (e.g., 911 call) reporting a burglary in progress. The operator instructs computer 214 to assign this incident to Officer Fred. Officer Fred is assigned a CAD ID corresponding to a burglary in progress. Because of this, Officer Fred's notifications on device 102 will be tailored to the situation of a burglary in progress. So, for example, a first set of applications will be deemed “important” and given priority. Popup notifications from applications from a second set of applications that are deemed “less important” will have their notifications occupy a smaller portion of a screen than those deemed important.

It should be noted that an application may be further “divided” into important and not important based on other factors such as what information is to be conveyed by the application. So, for example, an application that receives a push-to-talk call (or a regular phone call) may be deemed unimportant if a call from a first person is received, yet be deemed important if a call from another person is received. As above, the importance is also based on what kind of public-safety event is taking place.

In another example, Officer Ethan and his teammates are assigned to patrol in one area with CAD ID #ABC123, while Officer Darren and his teammates are assigned to patrol in another different area with CAD ID #DEF456. During patrolling, Officer Ethan found something threatening at an abandoned house and drew his gun. Officers assigned to CAD ID #ABC123 will have a first set of applications deemed “important” due to the fact that a gun has been drawn, and a second set of applications deemed “less important” based on the fact that the gun has been drawn.

In another example, Officer Ethan is patrolling with his tablet and RSM (remote speaker microphone) worn on his body. When he sees a suspicious person and queries about the person. At a later time, Officer Ethan spies another suspicious person running. Officer Ethan pursues the person and his motion sensor detects running, generates a CAD ID associated with a pursuit, and assigns priorities to applications based on the incident type (CAD ID).

With the above in mind, hub 102 will determine an application priority from a public-safety event (CAD ID, sensor state, . . . , etc.). A size and location of any popup for an application will be based on the application's priority. The Application's priority may be determined by determining a public-safety event and accessing a database that stores application priorities based on event. Such a database is illustrated below in tables 1 and 2.

TABLE 1
Database of incident type and priority state of applications.

| CAD ID | Incident Type | High-priority applications/calls |
|---|---|---|
| 0001 | Armed Robbery | Push-to-Talk, messaging, |
| | | communications from Officer |
| | | Jones, . . . |
| 0002 | Vehicle Citation | All Applications |
| 0003 | Foot Pursuit | Push-to-Talk, location/mapping, |
| | | communications from Officer |
| | | Smith |
| . . . | . . . | . . . |

The database may also comprise a table of sensor states and application priorities. This is shown below in Table 2.

TABLE 2
Database of Application Priority Based on Sensor State

| Sensor and its state | High-Priority Applications |
|---|---|
| Gun draw sensor indicates no gun | All Applications |
| drawn | |
| Gun draw sensor indicates gun has been | Push-to-Talk, Communications |
| drawn | from Dispatch, . . . |
| Accelerometer indicates walking | All Applications |
| Accelerometer indicates running | Push-to-Talk, location/mapping, |
| | Communications from Officer |
| | Smith, . . . |
| . . . | . . . |

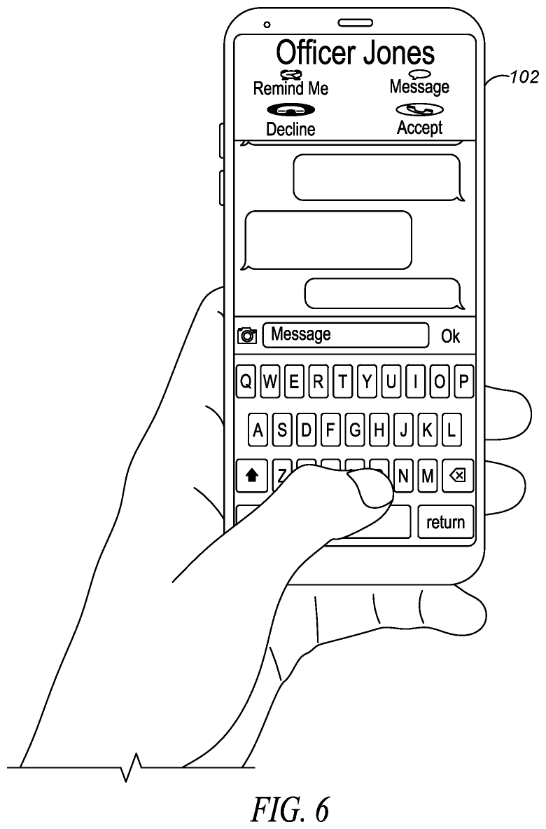

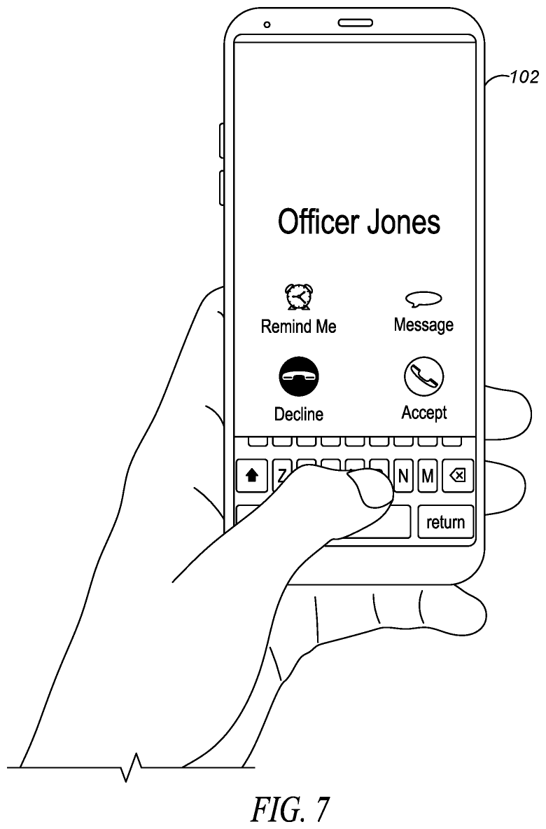

FIG. 4 is a block diagram of hub 102. As shown in FIG. 5, hub 102 includes a wide-area-network (WAN) transceiver 401 (e.g., a transceiver that utilizes a public-safety communication-system protocol), PAN transceiver 402 (e.g., a short-range transceiver), database 405, logic circuitry 403, and display 404. In other implementations, hub 102 may include more, fewer, or different components.

PAN transceiver 402 may be well known short-range (e.g., 30 feet of range) transceivers that utilize any number of network system protocols. For example, PAN transceiver 402 may be configured to utilize Bluetooth communication system protocol for a body-area network, or a private 802.11 network. PAN transceiver forms the PAN (acting as a master device) with various sensors 212.

Database 405 comprises standard memory (such as RAM, ROM, . . . , etc) and serves to store PAN member names (identifications), their statuses, and any incident assigned to hub 102. So, for example, database 410 may comprise a list of PAN members (long gun, bullet-proof vest, gun-draw sensor, accelerometer, . . . , etc.) that formed a PAN with hub 102. Database 410 also store status information for each sensor (e.g., long gun in use, bullet-proof vest being worn, dun-draw sensor indicating a gun is holstered, . . . , etc.). This information is received from PAN transceiver as sensor data. Similarly, database may store CAD IDs received from the dispatch center (or generated by hub 102). Finally, information included in Table 1 and Table 2 is stored in database 405.

WAN transceiver 401 may comprise well known long-range transceivers that utilize any number of network system protocols. (As one of ordinary skill in the art will recognize, a transceiver comprises both a transmitter and a receiver for transmitting and receiving data). For example, WAN transceiver 401 may be configured to utilize a next-generation cellular communications protocol operated by a cellular service provider, and/or any public-safety protocol such as an APCO 25 network or the FirstNet broadband network. WAN transceiver 401 receives communications from users, as well as sensor data from users. It should be noted that WAN transceiver 401 is shown as part of dispatch center 214, however, WAN transceiver 401 may be located in RAN 202 (e.g., a base station of RAN 202), with a direct link to dispatch center 214. WAN transceiver 401 can both transmit to, and receive information from public-safety officer's hub 102. Particularly, transceiver 401 is configured to receive voice communications (such as a user query) from a user operating hub 401. WAN transceiver is also configured to receive sensor data from hub 102, which is stored in database 264.

Logic circuitry 403 comprises a digital signal processor (DSP), general purpose microprocessor, a programmable logic device, or application specific integrated circuit (ASIC) and is configured to determine a priority of an application and adjust its notification window (popup window) as described above.

Finally, display 404 comprises any interface capable of displaying information to a user. Such an interface may include a touch screen, a computer screen, a keyboard, or any other interface needed to output visual data to a user.

During operation, WAN transceiver 401 receives any incident assigned to an officer using hub 102 while PAN transceiver 402 continuously receives a status of sensors that form a PAN associated with the officer using hub 102. These are passed to microprocessor 403, which stores a current status of the officer (CAD ID and sensor statuses) in database 405.

As one of ordinary skill in the art will recognize, microprocessor 403 also runs multiple, simultaneous applications stored as software in database 405. Application software comprises any program, or group of programs, that is designed for the end user. Applications software (also called end-user programs) include such things as database programs, Push-to-Talk applications, messaging applications, word processors, Web browsers, calendars, spreadsheets, . . . , etc.

Based on the sensor status and any assigned incident, logic circuitry 403 determines a priority for each running application. This is preferably determined by accessing tables 1 and 2, stored in database 405. When a running application sends a popup notification to display 404, logic circuitry 403 will tailor the display of the popup based on its current priority. More particularly, if the current priority of the application is high (based on sensor status and assigned incident), then the popup will appear normally, occupying a large portion of the screen (e.g., above 50% of the screen). If, however, the current priority of the application is low, then the popup will appear in a restricted area and location of display 404 (e.g., upper left corner of display 404, occupying less than 20% of the screen). It should be noted that if no incident is assigned to an officer, and if all sensors are in a normal range, then all applications will have a high priority, and have their popup notifications treated equally.

FIG. 5 through FIG. 8 illustrate displaying a popup notification for a high priority and a low priority application (low priority applications comprise any application that is not a high-priority application). FIG. 5 shows an officer typing a message on hub 102 using a messaging application. While typing the message, logic circuitry 403 receives a notification that a call from officer Jones is received. Assuming that the messaging application is deemed a high-priority application, and that Officer Jones's call is not a high-priority call (application), then the popup notification will occupy a small portion of the screen, located away from an area that would interfere with typing in the messaging application. This is shown in FIG. 6, where the notification occupies a small portion of the screen (around 15%) and is located at the top portion of the screen.

If, however, the messaging application was not identified as a high-priority application, and the call from officer Jones was identified as a high-priority application, then any popup notification that a call is received from Officer Jones will occupy a larger portion of the screen than in FIG. 6. This is illustrated in FIG. 7.

As discussed above, low-priority applications will have their popup notifications from applications restricted in size and location. The restriction may be such that they occupy none of the screen while a high-priority application is being shown on the screen. For example, if a sensor has detected a gun has been drawn, an emergency PTT application may be run so that backup can be summoned quickly. Any incoming application preemption may be ignored (not displayed) until gun is holstered.

FIG. 8 illustrates how the location of a popup notification may be adjusted based on a priority of applications. In this situation, a call from Officer Jones is identified as a high-priority application, and will be centered on the screen instead of shifted to the top, side, or bottom (for those applications not identified as high priority).

In another embodiment of the present invention, a content of a message may be analyzed and a priority of a popup may be determined based on the context of the message. Thus, for messaging applications, the content of any message may be analyzed to determine its priority. In this situation, logic circuitry 403 will look for certain key words to determine a priority of any message being created or received. For example, if a messaging application is receiving terms such as “emergency”, “robbery”, “assault”, . . . , etc., the particular message being created/received by the application may be deemed high priority.

As an example of the above, assume that an officer is typing a message on a messaging application. The content of the typed message may be analyzed to determine a priority of the typed message. Again, the priority of the typed message may also be based on a current public-safety event, so that certain terms will identify a message as high priority only when a particular public-safety event is taking place.

In a similar manner, the context of a received message may be analyzed to determine its priority. A popup notification for the received message will be displayed only if it is determined that the received message has a higher priority than the current application being displayed. Alternatively, a popup notification for the received message may be restricted as described above if it is determined that the received message does not have a higher priority than the currently-displayed application.

Thus, for incoming messages, a context of the message may be analyzed to determine how the popup notification will be displayed. For a user currently accessing a messaging application, the context of the message may be analyzed to determine its priority.

In yet a further embodiment of the present invention, a size of any popup notification will get larger as a user completes a task in a currently-running application. So for example, if a user is typing a message in a messaging application, and a small popup appears, the small popup may grow larger as the user continues to type. Logic circuitry 403 may increase the popup size (e.g., by 5%) for every letter typed. The percentage completion of any task may be used to determine popup size. Logic circuitry 403 will determine how much of a particular task is completed by first determining the context of the current application and the requirements to complete the task in the current application in correlation with user's context and incident type. In an example of a text messaging application, user receives a message and types a reply message. The original size of the popup window will be adjusted to 70% of the screen from some beginning percentage when user completes the reply message.

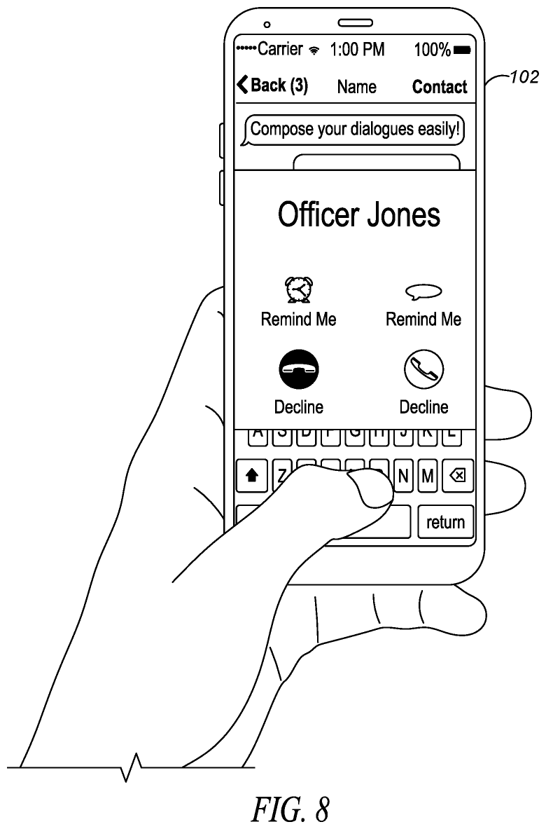

FIG. 9 is a flow chart showing operation of hub 102. The logic flow begins at step 1001 where logic circuitry 403 receives a notification from an application. As discussed above, logic circuitry 403 may be continuously running a number of simultaneous applications, any number of them can provide a notification to logic circuitry.

The logic flow continues to step 1003 where logic circuitry 403 accesses database 405 and determines a priority of the application based on an incident type, sensor data, and/or a content of a message. As discussed above, the incident type may comprise a computer-aided dispatch identification (CAD ID), while the sensor data may be received from a plurality of sensors that form a PAN.

At step 1005, logic circuitry 403 then causes display 404 to display a popup notification, the popup notification having a size based on the priority of the application.

As discussed above, when the application comprises a messaging application and the priority of the messaging application is further based on a content of a message. Additionally, the location of the popup notification may also be based on the priority of the application.

As is evident, the priority of the application is not static, but varies based on a current incident type and/or sensor state.

Thus, hub 102 provides for an apparatus comprising a display, a database configured to store application priorities that are based on incident types and/or sensor data, and logic circuitry configured to receive a notification from an application and access the database to determine a priority of the application and output a popup notification to the display, the popup notification having a particular size and location, wherein the size of the popup notification is based on the priority of the application.

When the application comprises a messaging application, the priority of the application may be further based on a content of a message.

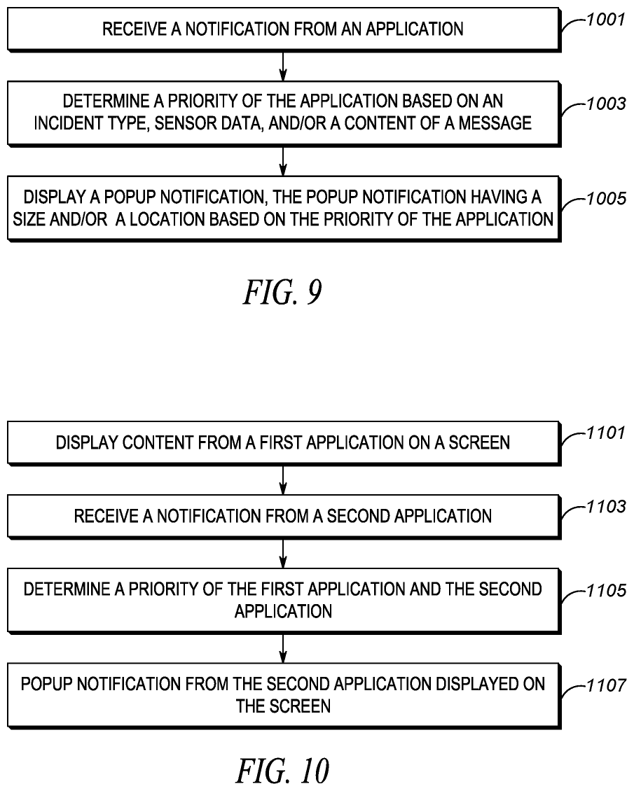

As discussed above, in one embodiment of the present invention, a priority of a first, currently-displayed application is also considered when determining whether or not to display a popup notification from a second application. This is illustrated in the flow chart of FIG. 10.

The logic flow begins at step 1101 where display 404 is displaying content from a first application on a screen. At step 1103 logic circuitry 403 receives a notification from a second application and determines a priority of the first application and the second application (step 1105). Logic circuitry 403 then causes a popup notification from the second application to be displayed on the screen at step 1107, wherein the popup notification has a size based on the priority of the first application and a priority of the second application, and wherein the priority of the first application and the priority of the second application is based on a public-safety incident type, a sensor state of at least one sensor forming a personal-area network (PAN), and/or content of a message, and wherein the priority of the first application and the priority of the second application are not static, but change based on the public-safety incident type and/or the sensor state of the at least one sensor forming the PAN.

As stated above, when the first or the second application comprises a messaging application, the priority of the first or the second application can be further based on a content of a message.

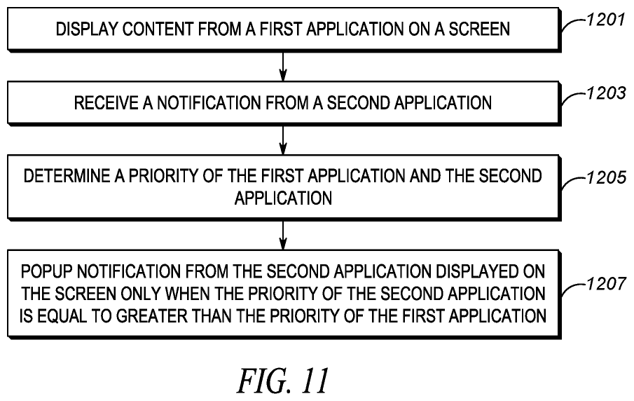

As discussed above, logic circuitry 403 may decide not to display popup notifications from lower-priority applications, and only display popup notifications when the notification is from an application having a same or higher priority than an application currently displaying information on display 404. This is illustrated in FIG. 11.

The logic flow begins at step 1201 where display 404 is displaying content from a first application on a screen. At step 1203 logic circuitry 403 receives a notification from a second application. At step 1205, logic circuitry 403 determines a priority of the first application and the second application and displays a popup notification from the second application on the screen only when the priority of the second application is equal to greater than the priority of the first application (step 1207). As discussed above, the priority of the first application and the priority of the second application is based on a public-safety incident type, a sensor state of at least one sensor forming a personal-area network (PAN), and/or content of a message, and wherein the priority of the first application and the priority of the second application are not static, but change based on the public-safety incident type and/or the sensor state of the at least one sensor forming the PAN.

In the foregoing specification, specific embodiments have been described.

However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a display;
a database configured to store application priorities that are based on incident type, sensor data, and/or message content;
logic circuitry configured to receive a notification from an application and access the database to determine a priority of the application and output a popup notification to the display, the popup notification having a particular size and location; and
wherein the size of the popup notification is based on the priority of the application.

2. The apparatus of claim 1 wherein the application comprises a messaging application and the priority of the application is based on only a content of the message.

3. The apparatus of claim 1 wherein:
the location of the popup notification is based on the priority of the application.

4. The apparatus of claim 1 wherein the sensor data comprises sensor data for a public-safety officer that comprises information from sensors forming a personal-area network (PAN) associated with the public-safety officer.

5. The apparatus of claim 1 wherein the incident type comprises a computer-aided dispatch identification (CAD ID) assigned to a public-safety officer.

6. The apparatus of claim 1 wherein the priority of the application is not static, but varies based on an incident type and/or sensor state.

7. A method comprising the steps of:
receiving a notification from an application;
determining a priority of the application based on an incident type, sensor data, or content of a message; and
displaying a popup notification on a display, the popup notification having a size based on the priority of the application.

8. The method of claim 7 wherein the application comprises a messaging application and the priority of the messaging application is only based on the content of the message.

9. The method of claim 7 wherein the incident type comprises a computer-aided dispatch identification (CAD ID).

10. The method of claim 7 further comprising the step of:
receiving the sensor state data from a plurality of sensors that form a PAN.

11. The method of claim 7 wherein:
the location of the popup notification is also based on the priority of the application.

12. The method of claim 7 wherein the priority of the application is not static, but varies based on a current incident type and/or sensor state.

13. A method comprising the steps of:
displaying content from a first application on a screen;
receiving a notification from a second application;
determining a priority of the first application and the second application;
displaying a popup notification from the second application on the screen;
wherein the popup notification has a size based on the priority of the first application and a priority of the second application;
wherein the priority of the first application and the priority of the second application is based on a public-safety incident type, a sensor state of at least one sensor forming a personal-area network (PAN), and/or content of a message; and
wherein the priority of the first application and the priority of the second application are not static, but change based on the public-safety incident type and/or the sensor state of the at least one sensor forming the PAN.

14. The method of claim 13 wherein the first application comprises a messaging application and wherein the priority of the first application is based only on the content of the message.

15. The method of claim 13 wherein the second application comprises a messaging application and wherein the priority of the second application is based only on the content of the message.

16. A method comprising the steps of:
displaying content from a first application on a screen;
receiving a notification from a second application;
determining a priority of the first application and the second application;
displaying a popup notification from the second application on the screen only when the priority of the second application is equal to greater than the priority of the first application;
wherein the priority of the first application and the priority of the second application is based on a public-safety incident type and/or a sensor state of at least one sensor forming a personal-area network (PAN), and/or content of a message; and
wherein the priority of the first application and the priority of the second application are not static, but change based on the public-safety incident type and/or the sensor state of the at least one sensor forming the PAN.
